(19) United States
(12) Patent Application Publication
(10) Pub. No.: US 2025/0369258 A1
(43) Pub. Date: Dec. 4, 2025

(54) ARRANGEMENT FOR LOCK SYSTEM, AND LOCK SYSTEM

(71) Applicant: ASSA ABLOY AB, Stockholm (SE)

(72) Inventor: Harald VESTØL, Kolbotn (NO)

(21) Appl. No.: 18/876,376

(22) PCT Filed: Jul. 5, 2023
(86) PCT No.: PCT/EP2023/068483

§ 371 Date: Dec. 18, 2024

(30) Foreign Application Priority Data
Jul. 7, 2022 (SE) 2230224-4

(51) Int. Cl. E05B 63/04; E05B 13/00; E05B 15/00; E05B 47/06; E05B 63/10; E05B 63/16

(52) U.S. Cl. CPC E05B 63/04; E05B 13/004; E05B 15/0033; E05B 47/0669; E05B 63/10; E05B 63/16

(57) ABSTRACT

An arrangement for a lock system comprising a latch spindle for engaging a follower and comprising a handing structure; an outer spindle comprising an outer engaging structure configured to engage the handing structure; and an inner spindle comprising an inner engaging structure configured to engage the handing structure independently of the outer engaging structure; wherein the handing structure, the inner engaging structure and the outer engaging structure are configured to cooperate such that a first handing can be set by a first latch position of the latch spindle, and a second handing can be set by a second latch position of the latch spindle; and wherein the handing structure comprises an angular clearance such that the inner spindle can drive the latch spindle relative to the outer spindle by engagement between the inner engaging structure and the handing structure.

### TECHNICAL FIELD

The present disclosure generally relates to an arrangement for a latch system. In particular, an arrangement comprising a latch spindle having a handing structure, and a latch system comprising such arrangement, are provided.

### BACKGROUND

In some known lock systems, an outer handle on an outer side of a door can be selectively prevented from driving a bolt. The handle function on the opposite inner side of the door may be permanently engaged with the bolt for safety reasons. Locking and unlocking of the outer handle function is typically effected electromechanically, for example by means of a solenoid arrangement or the like in the lock system. The solenoid arrangement may be controlled by a keypad, card reader or similar, or by remote control. Such electrically operated lock devices can for example be fitted to interior doors, such as hotel room doors.

There are four different types of handings of a door, namely right hand (RH), left hand (LH), right hand reverse (RHR) and left hand reverse (LHR). Some prior art lock systems rely on dedicated components in dependence of the handing of the door. In other words, the hardware for a lock system for a first type of handing differs from the hardware for a lock system for a second type of handing. This makes it necessary to produce a relatively high number of components and to provide storage for these components. Moreover, customers may not always know the handing of the door when ordering the lock system.

### SUMMARY

One object of the invention is to provide an improved arrangement for a lock system.

A further object of the invention is to provide an improved lock system comprising an arrangement.

These objects are achieved by the arrangement according to appended claim 1 and the lock system according to appended claim 11.

The invention is based on the realization that by providing an arrangement comprising a latch spindle having an angular clearance and where the latch spindle can be driven independently by each of an outer spindle and an inner spindle, the latch spindle can be positioned in four different positions in relation to a follower where each position corresponds to a unique handing, and the angular clearance enables the inner spindle to drive the latch spindle in each handing even if the outer spindle is locked.

According to a first aspect, there is provided an arrangement for a lock system, the arrangement comprising a latch spindle for engaging a follower of the lock system and for rotation about a follower axis, the latch spindle comprising a handing structure; an outer spindle for rotation about the follower axis, the outer spindle comprising an outer engaging structure configured to engage the handing structure; and an inner spindle for rotation about the follower axis, the inner spindle comprising an inner engaging structure configured to engage the handing structure independently of the outer engaging structure; wherein the handing structure, the inner engaging structure and the outer engaging structure are configured to cooperate such that a first handing of the lock system can be set by a first latch position of the latch spindle about the follower axis, and a second handing of the lock system can be set by a second latch position of the latch spindle, different from the first latch position, about the follower axis; and wherein the handing structure comprises an angular clearance with respect to the follower axis such that the inner spindle can drive the latch spindle relative to the outer spindle by engagement between the inner engaging structure and the handing structure.

The arrangement enables four different handings to be set in the lock system with a single latch. This in turn enables a more efficient production and storage of components for the arrangement. Moreover, for each handing, the angular clearance enables the latch spindle to be rotated by rotation of the inner spindle even if the outer spindle is locked in a stationary state. Thus, security of the arrangement is ensured for each handing.

By inserting the latch spindle into the follower in a first insertion direction and positioning the latch spindle in the first latch position, a right hand (RH) handing of the lock system can be set. By inserting the latch spindle into the follower in the first insertion direction and positioning the latch spindle in the second latch position, a left hand (LH) handing of the lock system can be set. By inserting the latch spindle into the follower in a second insertion direction, opposite to the first insertion direction, and positioning the latch spindle in the first latch position, a right hand reverse (RHR) handing of the lock system can be set. By inserting the latch spindle into the follower in the second insertion direction and positioning the latch spindle in the second latch position, a left hand reverse (LHR) handing of the lock system can be set.

The handing structure may comprise a first stop and a second stop. The first stop and the second stop may be separated by the angular clearance. Before the latch spindle is inserted into the follower, the angular clearance may be arranged to allow the handing structure to rotate at least 20 degrees and/or less than 90 degrees about the follower axis relative to each of the outer engaging structure and the inner engaging structure from the first latch position to the second latch position. The angular clearance may for example extend at least 20 degrees and/or less than 180 degrees about the follower axis.

The handing structure may comprise a collar and the angular clearance. The first stop and the second stop may face in a tangential direction with respect to the follower axis at respective ends of the collar. The collar may have an angular extension with respect to the follower axis of less than 340 degrees and/or at least 180 degrees. Alternatively, or in addition, the handing structure may have a constant cross-sectional profile in planes transverse to the follower axis over a distance where outer engaging structure and the inner engaging structure engage the handing structure.

In the first latch position, each of the outer engaging structure and the inner engaging structure may engage the first stop but not the second stop. Conversely, in the second latch position, each of the outer engaging structure and the inner engaging structure may engage the second stop but not the first stop. In any case, each of the outer engaging structure and the inner engaging structure may be configured to engage the handing structure in a circumferential direction with respect to the follower axis. Each of the outer engaging structure and the inner engaging structure may be positioned in the radial clearance in each of the first latch position and the second latch position.

Due to the angular clearance and since the outer engaging structure is configured to engage the handing structure independently of the inner engaging structure, the latch spindle can be rotated about the follower axis to rotationally drive the follower by rotation of the outer spindle while the inner spindle is at standstill, and the latch spindle can be rotated about the follower axis to rotationally drive the follower by rotation of the inner spindle while the outer spindle is at standstill.

The latch spindle may be configured to engage the follower by a shape fit. For example, the latch spindle may have a latch spindle profile and the follower may have a follower profile matching the latch spindle profile. The latch spindle profile and the follower profile may define a plurality of distinct relative positions about the follower axis. A pitch between two distinct positions may correspond to the angular clearance.

The lock system may comprise a latch including the follower. The outer spindle may be engaged by an outer handle on an outer side of the latch and the inner spindle may be engaged by an inner handle on an inner side of the latch.

The latch spindle may comprise a through opening. In this case, the outer spindle may pass through the through opening. The through opening may be concentric with the follower axis.

The arrangement may further comprise an outer blocking structure fixed to the outer spindle; an inner blocking structure fixed to the inner spindle; and a blocking member for engaging each of the outer blocking structure and the inner blocking structure; wherein the blocking member is configured to be positioned in a first blocking position where the blocking member blocks rotation of the outer spindle and the inner spindle in a second follower direction about the follower axis when the first handing is set, and positioned in a second blocking position where the blocking member blocks rotation of the outer spindle and the inner spindle in a first follower direction, opposite to the second follower direction, about the follower axis when the second handing is set. The blocking member thus prevents an inner handle and an outer handle from being rotated in a direction opposite to an intended direction for unlatching the latch.

The blocking member may be a pin. The pin may be positioned in parallel with the follower axis in each of the first blocking position and the second blocking position.

Each of the outer blocking structure and the inner blocking structure May comprise an aperture for receiving the blocking member. The aperture may be a slot. Alternatively, or in addition, the aperture may have a main extension in a plane transverse to the follower axis.

The arrangement may further comprise a base member for being secured to a door leaf associated with the lock system. In this case, the base member May comprise a first hole for receiving the blocking member in the first blocking position and a second hole for receiving the blocking member in the second blocking position. Due to these holes, a technician can easily see the handing set by the arrangement during installation of the lock system. The base member may be a plate for being arranged parallel with a main extension plane of the door leaf. The inner spindle may extend through the base member.

The arrangement may further comprise a manually operable actuator rotatable about an actuation axis parallel with the follower axis. In this case, the blocking member may be arranged to block rotation of the manually operable actuator in a second actuating direction about the actuation axis when the blocking member is in the first blocking position, and arranged to block rotation of the manually operable actuator in a first actuating direction, opposite to the second actuating direction, about the actuation axis when the blocking member is in the second blocking position. Thus, a single blocking member can perform a plurality of different functions. As a consequence, a complexity of the lock system can be reduced.

The arrangement may further comprise an intermediate spindle arranged to be driven by the manually operable actuator to rotate about an intermediate axis parallel with each of the follower axis and the actuation axis. In this case, the intermediate spindle may be arranged to contact the blocking member in each of the first blocking position and the second blocking position to block rotation of the manually operable actuator. Thus, the blocking member can block rotation of each of the outer spindle, the inner spindle and the manually operable actuator.

The manually operable actuator may be a thumb turn. Alternatively, or in addition, the manually operable actuator may be positioned on the inside with respect to the door leaf associated with the lock system.

The arrangement may further comprise a torsion spring. In this case, the blocking member may be arranged to deform the torsion spring in each of the first blocking position and the second blocking position. The torsion spring may be a retainer spring. Also in this way, the blocking member can perform a plurality of different functions.

According to a second aspect, there is provided a lock system comprising an arrangement according to the first aspect. The lock system may be configured to be installed in a door leaf rotatable relative to a frame.

The lock system may further comprise an inner handle engaging the inner spindle and an outer handle engaging the outer spindle. Each of the engagement between the inner handle and the inner spindle and the engagement between the outer handle and the outer spindle may be accomplished by a shape fit. Each handle may be a handle lever or a knob.

The torsion spring may be arranged to clamp one of the inner handle and the outer handle. Due to the deformation of the torsion spring by the blocking member, the performance of the torsion spring can be improved, e.g. by clamping harder onto a handle.

The lock system may further comprise a latch including the follower. The follower may be configured to receive the latch spindle in each of a first insertion direction along the follower axis, and a second follower direction along the follower axis, opposite to the first insertion direction. The latch may be a tubular latch.

### BRIEF DESCRIPTION OF THE DRAWINGS

Further details, advantages and aspects of the present disclosure will become apparent from the following description taken in conjunction with the drawings, wherein:

FIG. 1: schematically represents a side view of a lock system comprising an arrangement when the lock system is installed in a door leaf;

FIG. 2: schematically represents a perspective view of the lock system;

FIG. 3: schematically represents a top view of a right hand handing of the lock system;

FIG. 4: schematically represents a top view of a left hand handing of the lock system;

FIG. 5: schematically represents a top view of a right hand reverse handing of the lock system;

FIG. 6: schematically represents a top view of a left hand reverse handing of the lock system;

FIG. 7: schematically represents a perspective exploded partial view of the lock system;

FIG. 8: schematically represents a perspective view of a latch spindle of the arrangement;

FIG. 9: schematically represents a perspective view of an inner spindle of the arrangement;

FIG. 10: schematically represents a perspective view of an outer spindle of the arrangement;

FIG. 11: schematically represents a perspective partial view of the lock system with a right hand handing;

FIG. 12: schematically represents a perspective partial view of the lock system with a left hand handing;

FIG. 13a: schematically represents a perspective partial front view of the arrangement when the latch spindle is in a first latch position;

FIG. 13b: schematically represents a cross-sectional perspective partial front view of the arrangement in FIG. 13a;

FIG. 14a: schematically represents a perspective partial front view of the arrangement when the latch spindle is in a second latch position;

FIG. 14b: schematically represents a cross-sectional perspective partial front view of the arrangement in FIG. 14a;

FIG. 15: schematically represents a perspective view of the arrangement;

FIG. 16a: schematically represents a perspective partial front view of the lock system with a right hand handing;

FIG. 16b: schematically represents a partial front view of the arrangement in FIG. 16a;

FIG. 17a: schematically represents a perspective partial front view of the lock system with a left hand handing;

FIG. 17b: schematically represents a partial front view of the arrangement in FIG. 17a;

FIG. 18: schematically represents a partial perspective rear view of the lock system;

FIG. 19: schematically represents a partial front view of the lock system with a right hand handing;

FIG. 20: schematically represents a partial front view of the lock system with a left hand handing; and

FIG. 21: schematically represents a partial front view of the lock system.

### DETAILED DESCRIPTION

In the following, an arrangement comprising a latch spindle having a handing structure, and a latch system comprising such arrangement, will be described. The same or similar reference numerals will be used to denote the same or similar structural features.

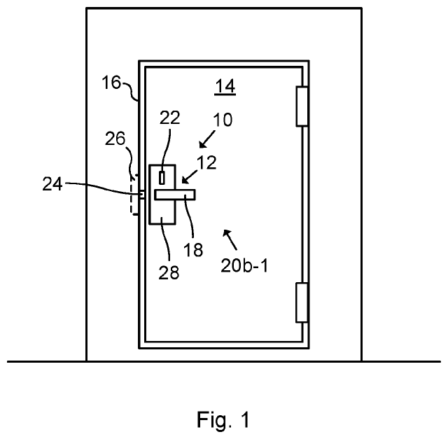

FIG. 1 schematically represents a side view of a lock system 10. The lock system 10 comprises an arrangement 12. In FIG. 1, the lock system 10 is installed in a door leaf 14. The door leaf 14 is rotatable relative to a frame 16.

FIG. 1 further shows an inner handle 18 of the lock system 10. FIG. 1 thus shows a view of the door leaf 14 from the inside. The door leaf 14 of this example opens to the inside. Thus, the lock system 10 has a left hand (LH) handing 20b-1.

The lock system 10 further comprises a thumb turn 22. The thumb turn 22 is one example of a manually operable actuator according to the present disclosure.

The lock system 10 further comprises a latch bolt 24. In FIG. 1, the latch bolt 24 engages a strike 26 in the frame 16.

The lock system 10 further comprises a housing 28. The housing 28 is fixed to the door leaf 14.

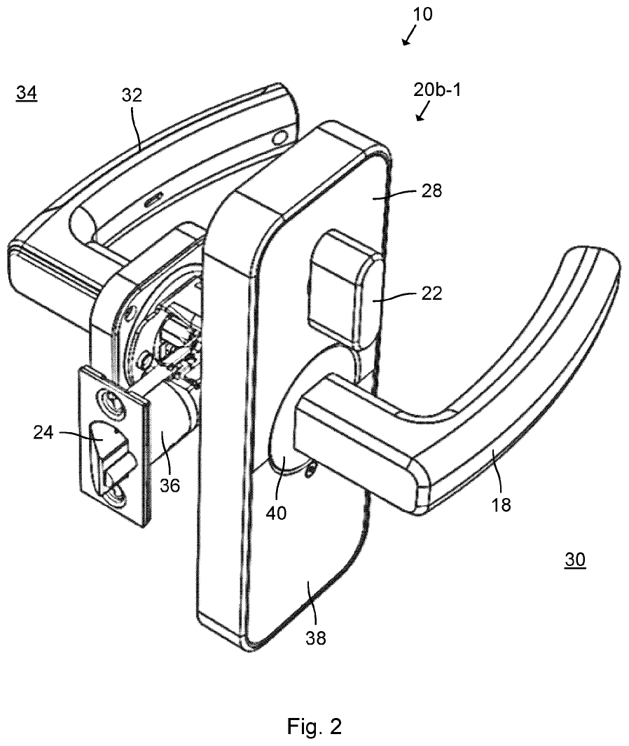

FIG. 2 schematically represents a perspective view of the lock system 10 in FIG. 1. The inner handle 18 is positioned on an inside 30 of the door leaf 14 (not shown in FIG. 2). In addition to the inner handle 18, the lock system 10 comprises an outer handle 32 positioned on an outside 34 of the door leaf 14.

The lock system 10 further comprises a latch 36. Except for a shape of a follower profile, as described below, the latch 36 may be a commercially available standard latch. The latch 36 is here exemplified as a tubular latch. The latch 36 comprises the latch bolt 24.

The lock system 10 of this example further comprises a base plate 38. The base plate 38 is one example of a base member according to the present disclosure. In this example, the housing 28 comprises the base plate 38. Thus, also the base plate 38 is secured to the door leaf 14. The housing 28 also comprises a cover 40 for the inner handle 18.

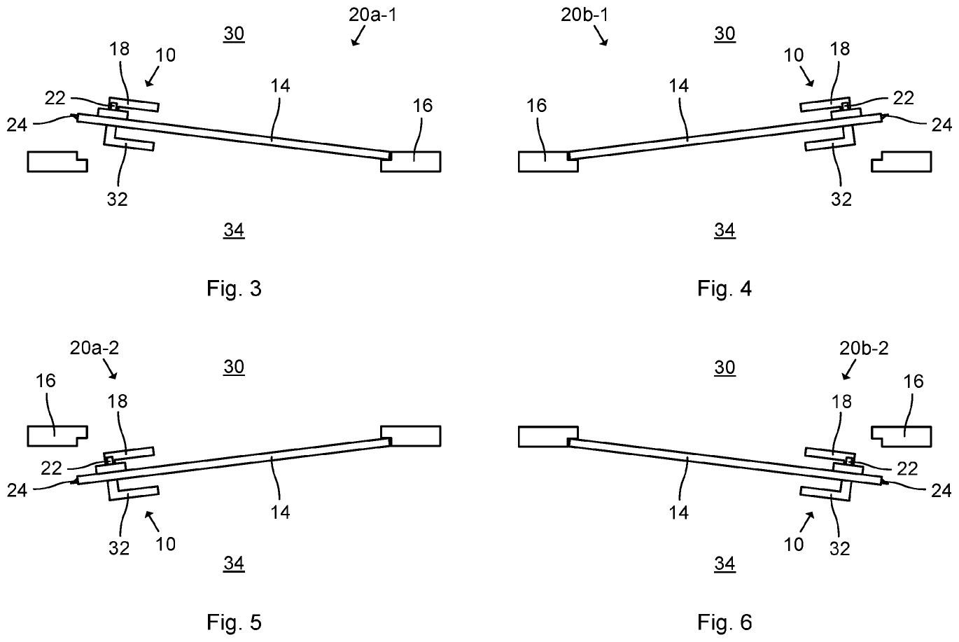

FIG. 3 schematically represents a top view of a right hand (RH) handing 20a-1 of the lock system 10, FIG. 4 schematically represents a top view of the left hand (LH) handing 20b-1 of the lock system 10, FIG. 5 schematically represents a top view of a right hand reverse (RHR) handing 20a-2 of the lock system 10, and FIG. 6 schematically represents a top view of a left hand reverse (LHR) handing 20b-2 of the lock system 10. One, several or all of the handings 20a-1, 20b-1, 20a-2 and 20b-2 may also be referred to with reference numeral “20”. As shown in FIGS. 3-6, the thumb turn 22 is positioned on the inside 30 for each handing 20. The orientation of the latch bolt 24 in relation to the lock system 10 differs between the RH handing 20a-1 and the RHR handing 20a-2 and between the LH handing 20b-1 and the LHR handing 20b-2.

The RH handing 20a-1 and the RHR handing 20a-2 constitute examples of first handings 20a according to the present disclosure. The LH handing 20b-1 and the LHR handing 20b-2 constitute examples of second handings 20b according to the present disclosure.

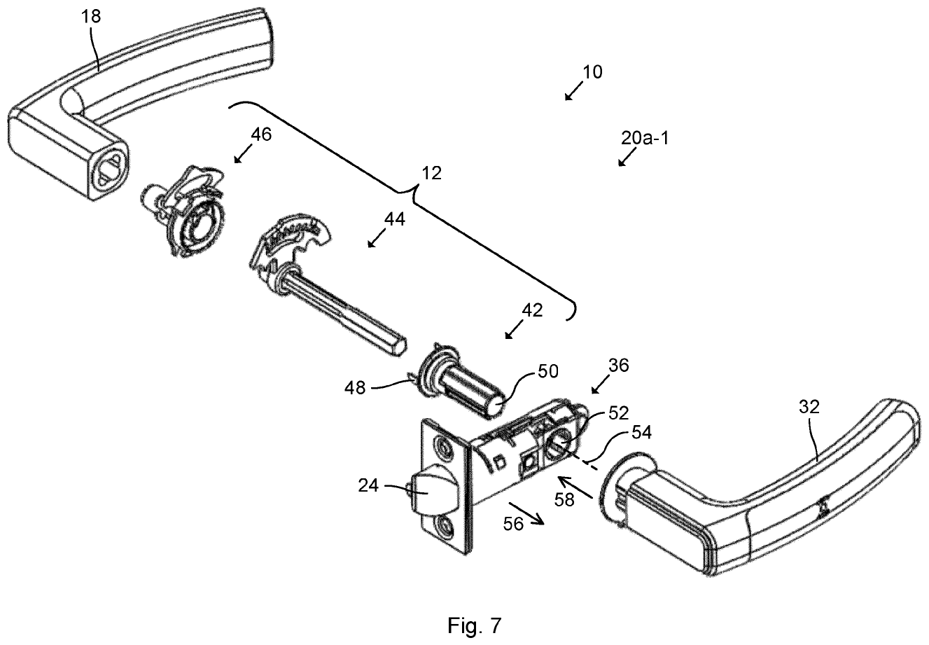

FIG. 7 schematically represents a perspective exploded partial view of the lock system 10. The arrangement 12 comprises a latch spindle 42, an outer spindle 44 and an inner spindle 46. The latch spindle 42 comprises a handing structure 48 and a through opening 50.

The latch 36 comprises a follower 52. The follower 52 is rotatable about a follower axis 54.

The follower 52 comprises a through hole for receiving the latch spindle 42. The latch spindle 42 is configured to engage the follower 52 by a shape fit. The latch spindle 42 has a latch spindle profile and the follower 52 has a follower profile corresponding to the latch spindle profile and for being engaged by the latch spindle profile. The latch spindle profile and the follower profile define a plurality of distinct relative positions about the follower axis 54. For a given position of the follower 52 about the follower axis 54, the latch spindle 42 can be inserted into the follower 52 in a plurality of (here six) unique positions about the follower axis 54.

The latch spindle 42 may be inserted into the follower 52 in either of a first insertion direction 56 along the follower axis 54, or a second insertion direction 58, opposite to the first insertion direction 56, along the follower axis 54. When the latch spindle 42 is inserted into the follower 52 in the first insertion direction 56, either the RH handing 20a-1 or the LH handing 20b-1 can be set. When the latch spindle 42 is inserted into the follower 52 in the second insertion direction 58, either the RHR handing 20a-2 or the LHR handing 20b-2 can be set. In any case, the latch spindle 42 is configured to engage the follower 52 for rotation about the follower axis 54.

The follower 52 may for example have a diameter of 20 mm to 40 mm, such as 27 mm. Alternatively, or in addition, the follower 52 may have a length along the follower axis 54 of 50 mm to 60 mm, such as 54.5 mm.

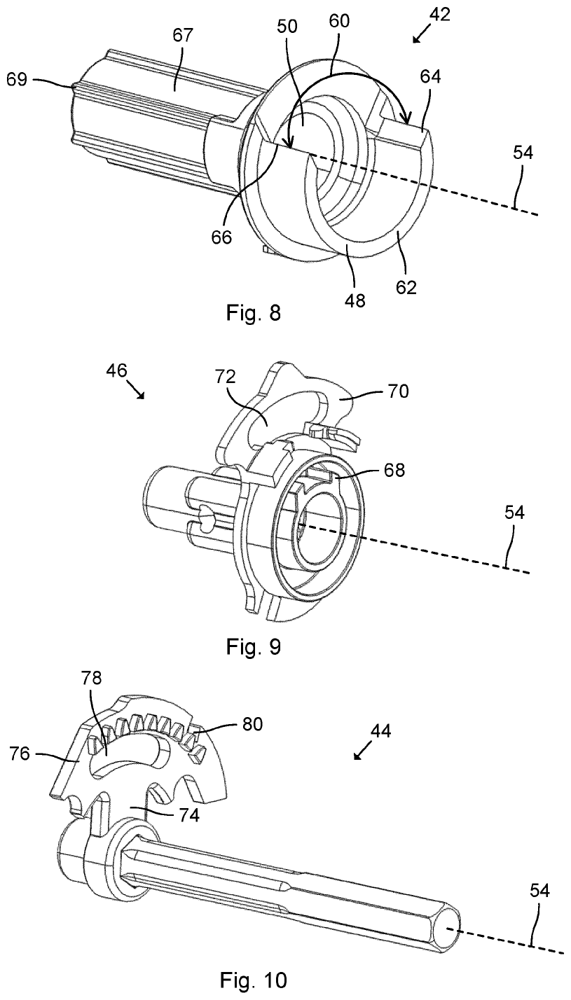

FIG. 8 schematically represents a perspective view of the latch spindle 42. As shown, the handing structure 48 comprises an angular clearance 60. In this specific and non-limiting example, the angular clearance 60 has an angular extension about the follower axis 54 of approximately 120 degrees.

The handing structure 48 of this example comprises a collar 62. The collar 62 is concentric with the follower axis 54. Due to the angular clearance 60, the collar 62 is not closed around the follower axis 54. The angular clearance 60 may thus be said to constitute an opening in the collar 62. The handing structure 48 in FIG. 8 has a constant cross-sectional shape along the follower axis 54 in planes transverse to the follower axis 54.

The handing structure 48 comprises a first stop 64 and a second stop 66, here provided as tangential (with respect to the follower axis 54) ends of the collar 62. The first stop 64 and the second stop 66 are separated by the angular clearance 60.

FIG. 8 further shows the latch spindle profile 67 of the latch spindle 42. In this specific example, the latch spindle profile 67 comprises a plurality of (here six) ridges 69. Each ridge 69 is parallel with the follower axis 54. The ridges 69 are evenly distributed in a circumferential direction about the follower axis 54. Thus, in this example of the latch spindle 42 comprising six ridges 69, the angular spacing between the ridges 69 is 60 degrees. As shown in FIG. 8, one ridge 69 is aligned with each of the first stop 64 and second stop 66.

As mentioned above, the follower profile of the follower 52 matches the latch spindle profile 67. Thus, the follower profile of this example has six notches, each for receiving one of the ridges 69. The latch spindle 42 can thus be positioned in six distinct positions about the follower axis 54 with respect to the follower 52. The pitch angle between these positions is 60 degrees in this example.

FIG. 9 schematically represents a perspective view of the inner spindle 46. The inner spindle 46 is configured to rotate about the follower axis 54. The inner spindle 46 comprises an inner engaging structure 68. The inner engaging structure 68 is configured to move within the angular clearance 60 between the first stop 64 and the second stop 66. In this way, the inner engaging structure 68 is configured to engage the handing structure 48.

The inner spindle 46 further comprises an inner blocking structure 70. The inner blocking structure 70 comprises an inner slot 72. The inner slot 72 is one example of an inner aperture according to the present disclosure. The inner slot 72 has a main extension in a plane transverse to the follower axis 54. The inner slot 72 is curved and concentric with the follower axis 54. The inner slot 72 of this example has an angular extension of at least 20 degrees.

FIG. 10 schematically represents a perspective view of the outer spindle 44. The outer spindle 44 is configured to rotate about the follower axis 54. The outer spindle 44 comprises an outer engaging structure 74. The outer engaging structure 74 is configured to move within the angular clearance 60 between the first stop 64 and the second stop 66. In this way, the outer engaging structure 74 is configured to engage the handing structure 48. The inner engaging structure 68 and the outer engaging structure 74 are configured to independently engage the handing structure 48.

The outer spindle 44 further comprises an outer blocking structure 76. The outer blocking structure 76 is positioned radially outside the outer engaging structure 74 with respect to the follower axis 54. The outer blocking structure 76 comprises an outer slot 78. The outer slot 78 is one example of an outer aperture according to the present disclosure. The outer slot 78 has a main extension in a plane transverse to the follower axis 54. The outer slot 78 is curved and concentric with the follower axis 54. The outer slot 78 of this example has an angular extension of at least 20 degrees.

The outer spindle 44 further comprises a notch 80, here provided in the outer blocking structure 76. The notch 80 is one example of an engageable feature for being engaged by a lock mechanism to lock the outer spindle 44 about the follower axis 54.

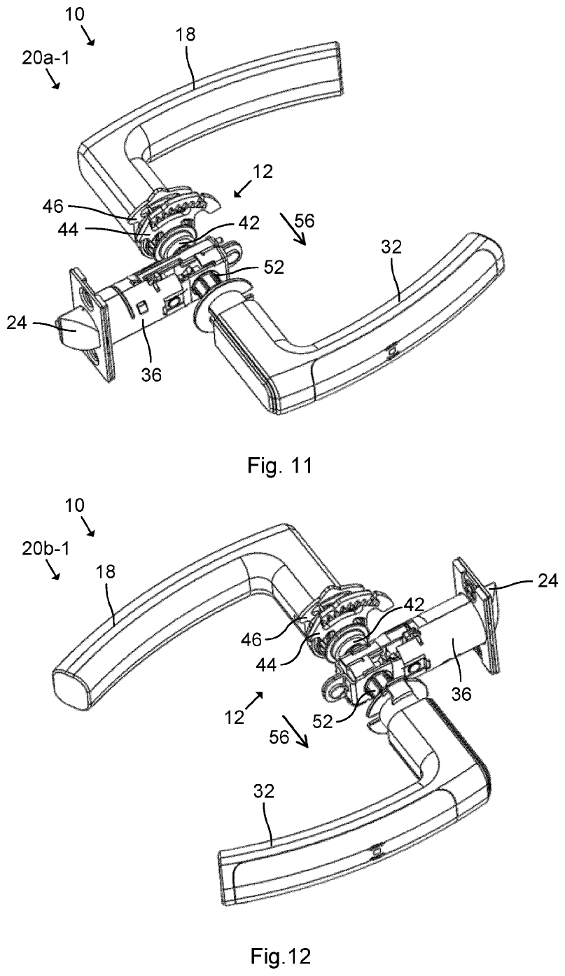

FIG. 11 schematically represents a perspective partial view of the lock system 10 with the RH handing 20a-1, and FIG. 12 schematically represents a perspective partial view of the lock system 10 with the LH handing 20b-1. In FIGS. 11 and 12, the positioning of the arrangement 12 in the lock system 10 for different handings 20 can be seen. In each of FIGS. 11 and 12, the latch spindle 42 has been inserted into the follower 52 in the first insertion direction 56 along the follower axis 54. However, the rotational position of the latch spindle 42 about the follower axis 54 is different between FIGS. 11 and 12. The arrangement 12 thus enables providing two different handings 20 by only changing a rotational position of the latch spindle 42 about the follower axis 54 for a neutral position of the follower 52.

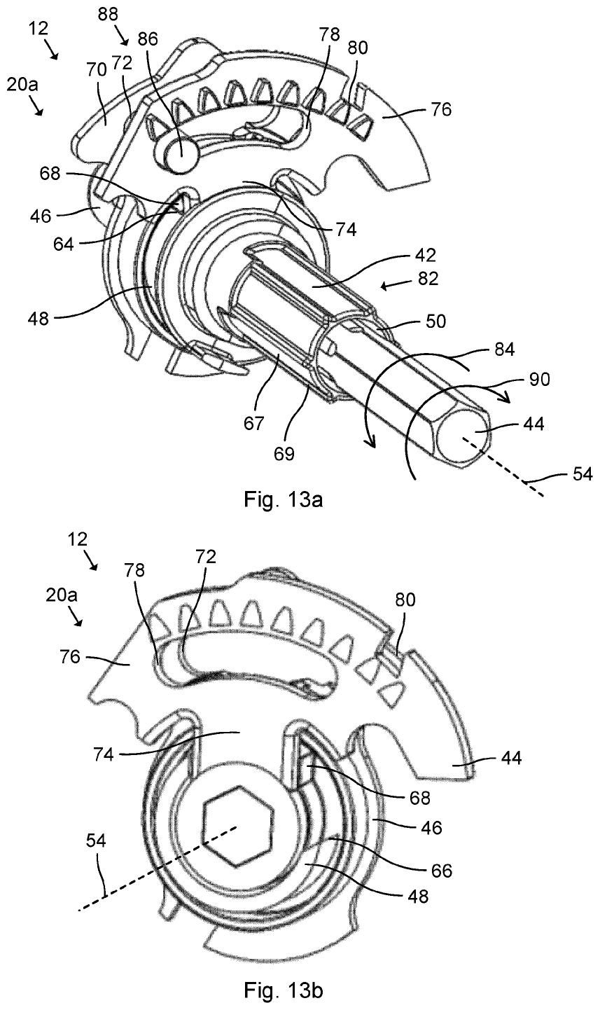

FIG. 13a schematically represents a perspective partial front view of the arrangement 12 when the latch spindle 42 is in a first latch position 82, and FIG. 13b schematically represents a cross-sectional perspective partial front view of the arrangement 12 in FIG. 13a. With collective reference to FIGS. 13a and 13b, the arrangement 12 has a first handing 20a due to the first latch position 82 of the latch spindle 42. The outer engaging structure 74 and the inner engaging structure 68 contact the first stop 64. The latch spindle 42, the outer spindle 44 and the inner spindle 46 are thus configured such the first handing 20a can be set by the first latch position 82.

The inner blocking structure 70 and the outer blocking structure 76 are contained within the housing 28. The outer spindle 44 passes through the through opening 50.

In the first latch position 82, the latch spindle 42 is rotated in a first follower direction 84 about the follower axis 54 when the outer spindle 44 is rotated in the first follower direction 84 due to the engagement between the outer engaging structure 74 and the handing structure 48. The latch spindle 42 is also rotated in the first follower direction 84 when the inner spindle 46 is rotated in the first follower direction 84 due to the engagement between the inner engaging structure 68 and the handing structure 48. Thus, the latch spindle 42 can be driven independently in the first follower direction 84 by any of the outer spindle 44 and the inner spindle 46 to effect retraction of the latch bolt 24.

Due to the angular clearance 60, the inner spindle 46 can be rotated in the first follower direction 84 to drive the latch spindle 42 even if the outer spindle 44 is held stationary due to being locked. During this rotation, the outer engaging structure 74 moves through the angular clearance 60. Thus, the arrangement 12 provides a safety function for the first handing 20a in that a user can always retract the latch bolt 24 and open the door leaf 14 regardless of a state of the outer spindle 44. The angular clearance 60, the outer engaging structure 74 and the inner engaging structure 68 may be configured such that the latch spindle 42 can rotate at least 20 degrees in the first follower direction 84 when the outer spindle 44 is locked when the arrangement 12 has the first handing 20a and the outer spindle 44 is locked.

The arrangement 12 of this example further comprises a blocking pin 86. The blocking pin 86 is one example of a blocking member according to the present disclosure. The blocking pin 86 is configured to engage each of the outer blocking structure 76 and the inner blocking structure 70. The blocking pin 86 is parallel with the follower axis 54.

In FIGS. 13a and 13b, the blocking pin 86 is in a first blocking position 88, here exemplified as the blocking pin 86 being inserted through an end (left end in FIGS. 13a and 13b) of each of the outer slot 78 and the inner slot 72. As a consequence, the blocking pin 86 blocks rotation of the outer spindle 44 and the inner spindle 46 in a second follower direction 90 about the follower axis 54, opposite to the first follower direction 84, when the first handing 20a is set. This prevents any of the inner handle 18 and outer handle 32 from being rotated upwards.

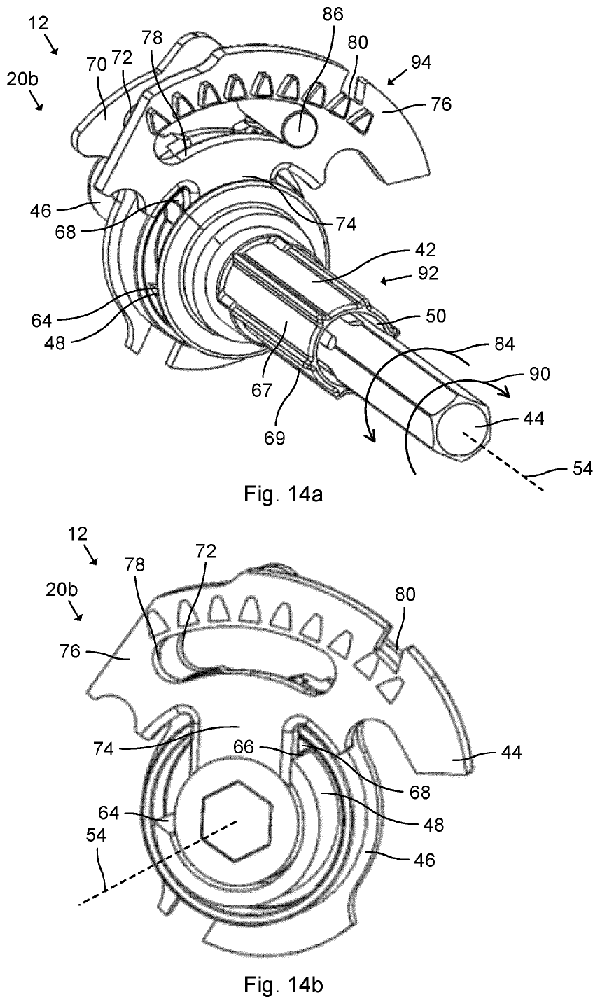

FIG. 14a schematically represents a perspective partial front view of the arrangement 12 when the latch spindle 42 is in a second latch position 92, and FIG. 14b schematically represents a cross-sectional perspective partial front view of the arrangement 12 in FIG. 14a. With collective reference to FIGS. 14a and 14b, the arrangement 12 now has a second handing 20b due to the second latch position 92 of the latch spindle 42. In this example, the latch spindle 42 has been rotated (prior to being inserted into the follower 52) 60 degrees about the follower axis 54 in the first follower direction 84 from the first latch position 82 to the second latch position 92. The outer engaging structure 74 and the inner engaging structure 68 contact the second stop 66. The latch spindle 42, the outer spindle 44 and the inner spindle 46 are thus configured such the second handing 20b can be set by the second latch position 92.

In the second latch position 92, the latch spindle 42 is rotated in the second follower direction 90 when the outer spindle 44 is rotated in the second follower direction 90 due to the engagement between the outer engaging structure 74 and the handing structure 48. The latch spindle 42 is also rotated in the second follower direction 90 when the inner spindle 46 is rotated in the second follower direction 90 due to the engagement between the inner engaging structure 68 and the handing structure 48. Thus, also in the second handing 20b, the latch spindle 42 can be driven independently in the second follower direction 90 by any of the outer spindle 44 and the inner spindle 46 to effect retraction of the latch bolt 24.

Due to the angular clearance 60, the inner spindle 46 can be rotated in the second follower direction 90 to drive the latch spindle 42 even if the outer spindle 44 is held stationary due to being locked. During this rotation, the outer engaging structure 74 moves through the angular clearance 60. Thus, the arrangement 12 provides a safety function also for the second handing 20b in that a user can always retract the latch bolt 24 and open the door leaf 14 regardless of a state of the outer spindle 44. The angular clearance 60, the outer engaging structure 74 and the inner engaging structure 68 may be configured such that the latch spindle 42 can rotate at least 20 degrees in the second follower direction 90 when the arrangement 12 has the second handing 20b and the outer spindle 44 is locked.

In FIGS. 14a and 14b, the blocking pin 86 is in a second blocking position 94, here exemplified as the blocking pin 86 being inserted through an end (right end in FIGS. 14a and 14b) of each of the outer slot 78 and the inner slot 72. As a consequence, the blocking pin 86 now blocks rotation of the outer spindle 44 and the inner spindle 46 in the first follower direction 84 when the second handing 20b is set. This prevents any of the inner handle 18 and the outer handle 32 from being rotated upwards.

The arrangement 12 thus enables a handing 20 of the lock system 10 to be easily set during installation of the lock system 10 while still ensuring the safety function of the lock system 10. A user may thus order the lock system 10 without specifying the handing 20.

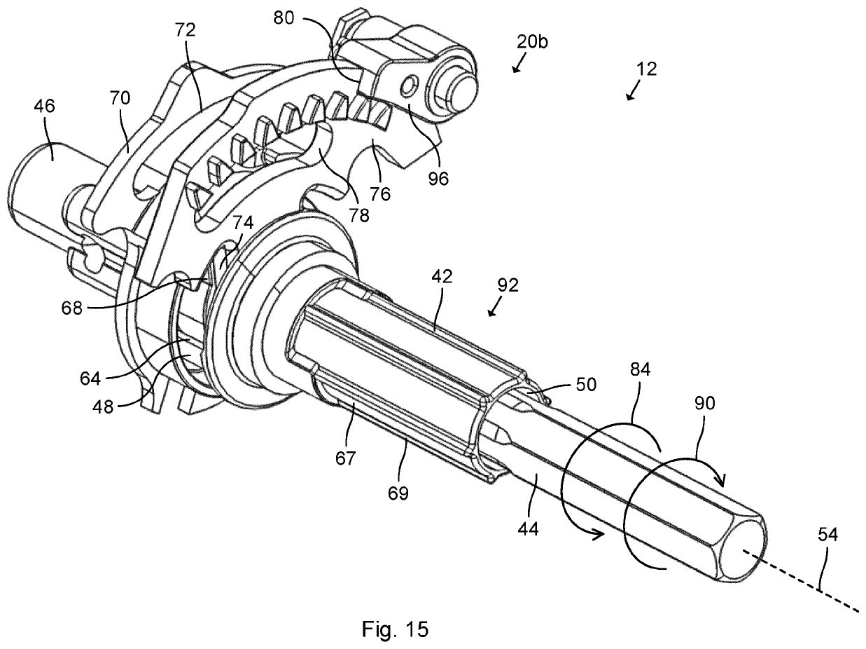

FIG. 15 schematically represents a perspective view of the arrangement 12. In FIG. 15, the arrangement 12 has the second handing 20b according to FIGS. 14a and 14b.

The lock system 10 of this example further comprises a lock mechanism 96. The lock mechanism 96 is configured to selectively lock and unlock the outer spindle 44 and thereby also the outer handle 32. The lock system 10 may further comprise an electronic control system (not shown). The control system may be configured to command unlocking of the lock mechanism 96, for example in response to a granted authorization procedure. The authorization procedure may comprise receiving, by the control system, a credential from a user. The credential may be input by the user in many different ways, for example wirelessly via radio-frequency identification (RFID). The authorization evaluation may further comprise evaluating the credential by the control system. The evaluation procedure may further comprise sending, by the control system, an access signal to the lock mechanism 96 upon determining that the credential is valid.

In FIG. 15, the lock mechanism 96 engages the notch 80 such that the outer spindle 44 is locked. The user may however still rotate the inner spindle 46 in the first follower direction 84 to drive the latch spindle 42.

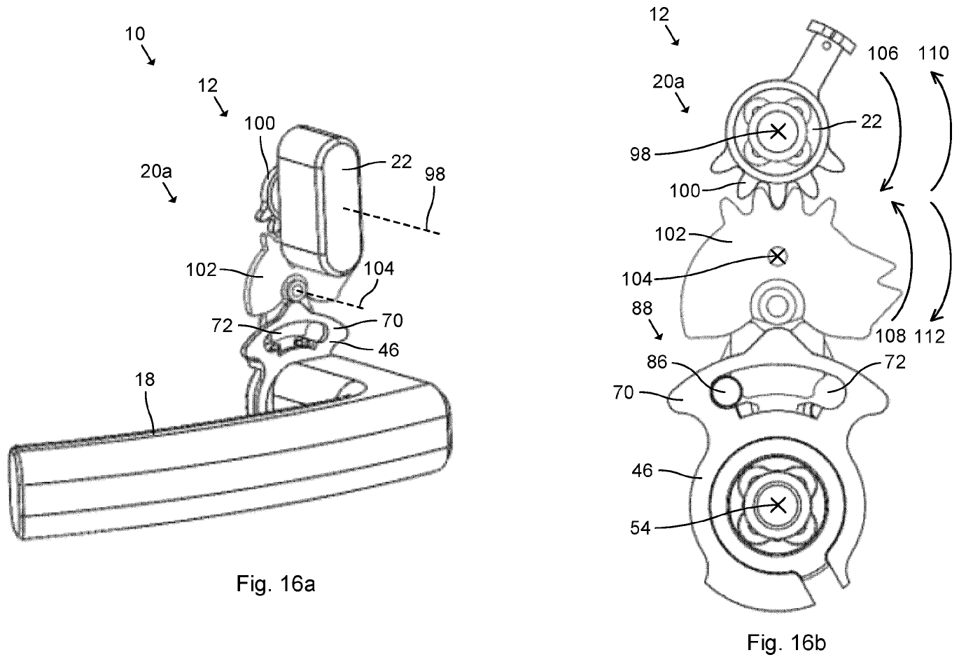

FIG. 16a schematically represents a perspective partial front view of the lock system 10 with a first handing 20a, and FIG. 16b schematically represents a partial front view of the arrangement 12 in FIG. 16a. The thumb turn 22 is rotatable about an actuation axis 98. The actuation axis 98 is parallel with the follower axis 54. The thumb turn 22 of this example comprises a drive gear 100, here concentric with the actuation axis 98.

The arrangement 12 of this example further comprises an intermediate spindle 102. The intermediate spindle 102 is rotatable about an intermediate axis 104. The intermediate axis 104 is positioned between the actuation axis 98 and the follower axis 54. The drive gear 100 drivingly engages the intermediate spindle 102, for example by gear teeth. The intermediate spindle 102 and the drive gear 100 are accommodated in the housing 28.

In FIGS. 16a and 16b, the arrangement 12 has a first handing 20a and the blocking pin 86 is positioned in the first blocking position 88. When the thumb turn 22 is rotated in a first actuating direction 106 about the actuation axis 98, the intermediate spindle 102 is driven to rotate in a first intermediate direction 108 about the intermediate axis 104. In case the thumb turn 22 is attempted to be rotated in a second actuating direction 110 about the actuation axis 98, opposite to the first actuating direction 106, the intermediate spindle 102 is attempted to be driven to rotate in a second intermediate direction 112 about the intermediate axis 104, opposite to the first intermediate direction 108. However, as shown in FIG. 16b, the blocking pin 86 in the first blocking position 88 contacts the intermediate spindle 102 and blocks rotation of the intermediate spindle 102 in the second intermediate direction 112. As a consequence, the blocking pin 86 in the first blocking position 88 blocks rotation of the thumb turn 22 in the second actuating direction 110.

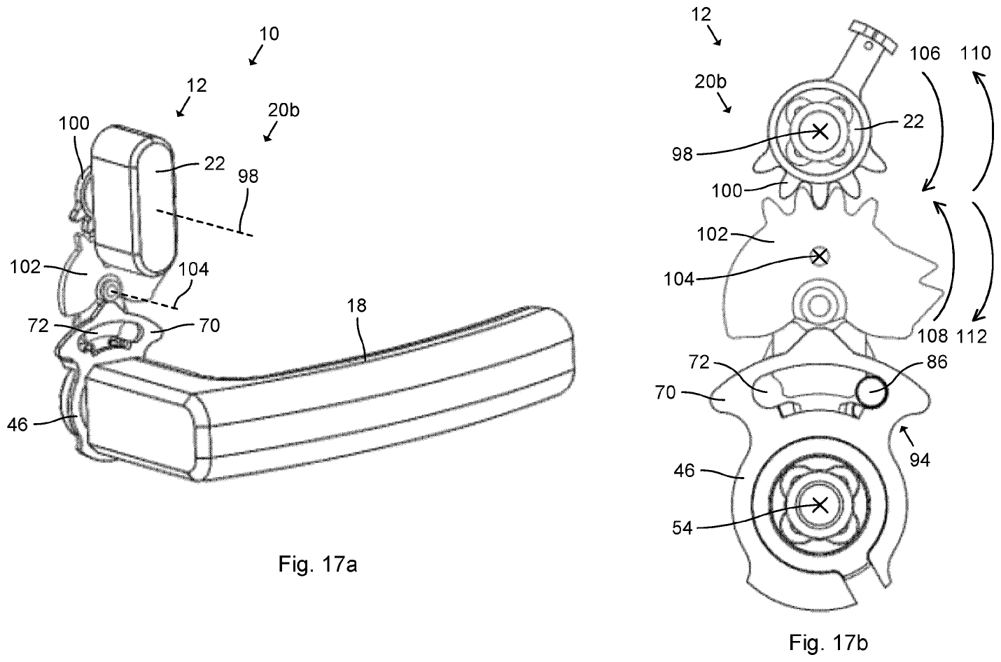

FIG. 17a schematically represents a perspective partial front view of the lock system 10 with a second handing 20b, and FIG. 17b schematically represents a partial front view of the arrangement 12 in FIG. 17a. In FIGS. 17a and 17b, the arrangement 12 has a second handing 20b and the blocking pin 86 is positioned in the second blocking position 94. When the thumb turn 22 is rotated in the second actuating direction 110 about the actuation axis 98, the intermediate spindle 102 is driven to rotate in the second intermediate direction 112 about the intermediate axis 104. In case the thumb turn 22 is attempted to be rotated in the first actuating direction 106 about the actuation axis 98, the intermediate spindle 102 is attempted to be driven to rotate in the first intermediate direction 108. However, as shown in FIG. 17b, the blocking pin 86 in the second blocking position 94 contacts the intermediate spindle 102 and blocks rotation of the intermediate spindle 102 in the first intermediate direction 108. As a consequence, the blocking pin 86 in the second blocking position 94 blocks rotation of the thumb turn 22 in the first actuating direction 106.

The blocking pin 86 is thus arranged to block rotation of the thumb turn 22 in the second actuating direction 110 when the blocking pin 86 is in the first blocking position 88 and to block rotation of the thumb turn 22 in the first actuating direction 106 when the blocking pin 86 is in the second blocking position 94. The blocking pin 86 of this example is thereby arranged to block rotation of each of the outer spindle 44, the inner spindle 46 and the thumb turn 22.

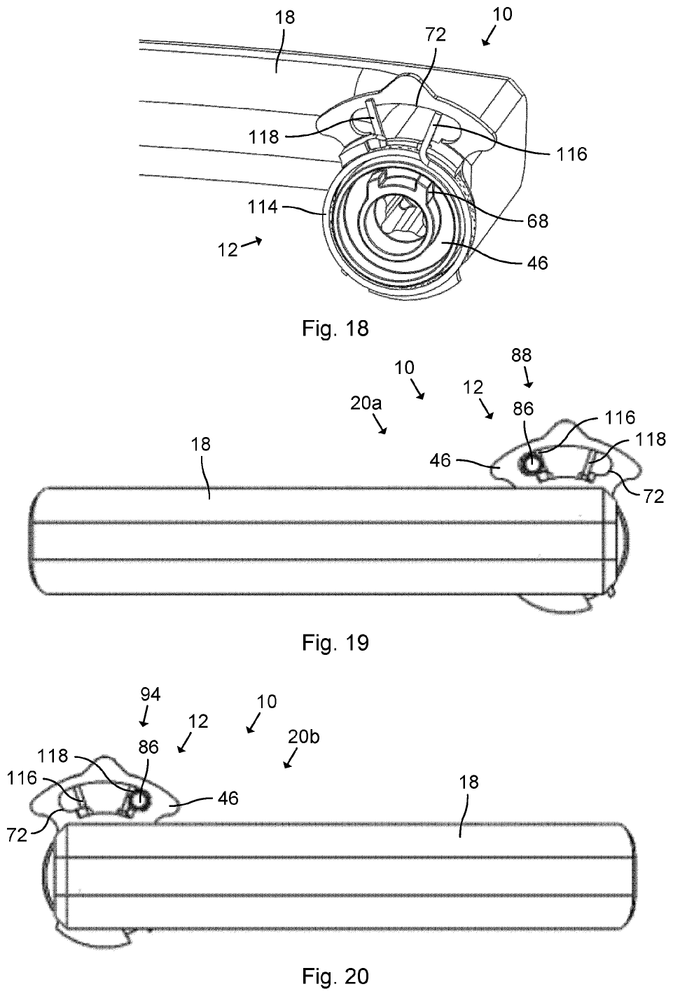

FIG. 18 schematically represents a partial perspective rear view of the lock system 10. The arrangement 12 of this example further comprises a torsion spring, here exemplified as a retainer spring 114. The retainer spring 114 provides a clamping force onto the inner handle 18. The retainer spring 114 of this example comprises a first leg 116, a second leg 118 and a coiled section providing the clamping force arranged between the first leg 116 and the second leg 118. Each of the first leg 116 and the second leg 118 extends across the inner slot 72.

FIG. 19 schematically represents a partial front view of the lock system 10 with a first handing 20a. As shown, when the blocking pin 86 is positioned in the first blocking position 88, the blocking pin 86 deforms the retainer spring 114 such that the clamping force is increased. In FIG. 19, the blocking pin 86 pushes the first leg 116 to the right.

FIG. 20 schematically represents a partial front view of the lock system 10 with a second handing 20b. As shown, also when the blocking pin 86 is positioned in the second blocking position 94, the blocking pin 86 deforms the retainer spring 114 such that clamping force is increased. In FIG. 20, the blocking pin 86 pushes the second leg 118 to the left.

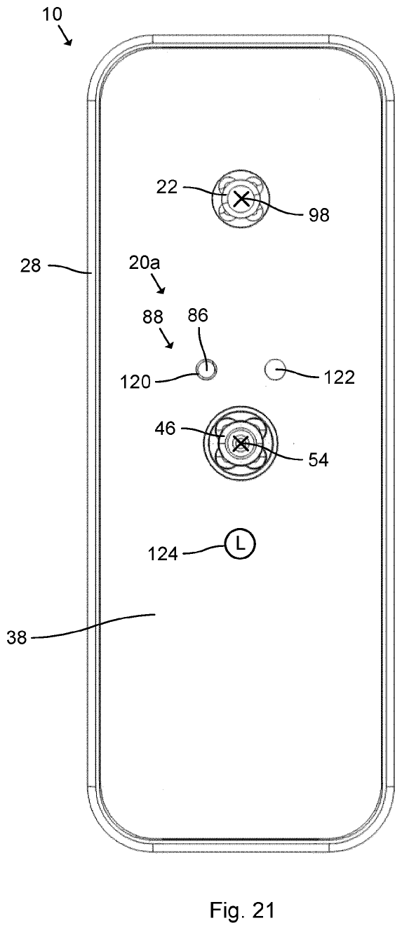

FIG. 21 schematically represents a partial front view of the lock system 10. In FIG. 21, the inner handle 18 is removed. The base plate 38 of this example comprises a first hole 120 and a second hole 122. In FIG. 21, the blocking pin 86 is received in the first hole 120 when being positioned in the first blocking position 88. The second hole 122 is configured to receive the blocking pin 86 in the second blocking position 94. The first hole 120 and the second hole 122 may be covered by the cover 40. By removing the cover 40, or prior to installing the cover 40, a technician can see from the exterior of the housing 28 whether the blocking pin 86 occupies the first hole 120 or the second hole 122, and consequently whether the blocking pin 86 is in the first blocking position 88 or the second blocking position 94.

The base plate 38 of this example may further comprise a window 124. A part of the latch spindle 42, or a part fixed to the latch spindle 42, may contain one identifier for each handing 20. As shown in FIG. 21, an example identifier in the form of letter “L” is visible through the window 124. In this way, a user can see that the arrangement 12 is in a certain handing based on the identifier.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-15. (canceled)

16. An arrangement for a lock system, the arrangement comprising:
a latch spindle for engaging a follower of the lock system and for rotation about a follower axis, the latch spindle comprising a handing structure;
an outer spindle for rotation about the follower axis, the outer spindle comprising an outer engaging structure configured to engage the handing structure; and
an inner spindle for rotation about the follower axis, the inner spindle comprising an inner engaging structure configured to engage the handing structure independently of the outer engaging structure;
wherein the handing structure, the inner engaging structure and the outer engaging structure are configured to cooperate such that a first handing of the lock system can be set by a first latch position of the latch spindle about the follower axis, and a second handing of the lock system can be set by a second latch position of the latch spindle, different from the first latch position, about the follower axis; and
wherein the handing structure comprises an angular clearance with respect to the follower axis such that the inner spindle can drive the latch spindle relative to the outer spindle by engagement between the inner engaging structure and the handing structure.

17. The arrangement according to claim 16, wherein the latch spindle comprises a through opening, and wherein the outer spindle passes through the through opening.

18. The arrangement according to claim 16, further comprising:
an outer blocking structure fixed to the outer spindle;
an inner blocking structure fixed to the inner spindle; and
a blocking member for engaging each of the outer blocking structure and the inner blocking structure;
wherein the blocking member is configured to be positioned in a first blocking position where the blocking member blocks rotation of the outer spindle and the inner spindle in a second follower direction about the follower axis when the first handing is set, and positioned in a second blocking position where the blocking member blocks rotation of the outer spindle and the inner spindle in a first follower direction, opposite to the second follower direction, about the follower axis when the second handing is set.

19. The arrangement according to claim 18, wherein the blocking member is a pin.

20. The arrangement according to claim 18, wherein each of the outer blocking structure and the inner blocking structure comprises an aperture for receiving the blocking member.

21. The arrangement according to claim 18, further comprising a base member for being secured to a door leaf associated with the lock system, wherein the base member comprises a first hole for receiving the blocking member in the first blocking position and a second hole for receiving the blocking member in the second blocking position.

22. The arrangement according to claim 18, further comprising a manually operable actuator rotatable about an actuation axis parallel with the follower axis, wherein the blocking member is arranged to block rotation of the manually operable actuator in a second actuating direction about the actuation axis when the blocking member is in the first blocking position, and arranged to block rotation of the manually operable actuator in a first actuating direction, opposite to the second actuating direction, about the actuation axis when the blocking member is in the second blocking position.

23. The arrangement according to claim 22, further comprising an intermediate spindle arranged to be driven by the manually operable actuator to rotate about an intermediate axis parallel with each of the follower axis and the actuation axis, wherein the intermediate spindle is arranged to contact the blocking member in each of the first blocking position and the second blocking position to block rotation of the manually operable actuator.

24. The arrangement according to claim 22, wherein the manually operable actuator is a thumb turn.

25. The arrangement according to claim 18, further comprising a torsion spring, wherein the blocking member is arranged to deform the torsion spring in each of the first blocking position and the second blocking position.

26. A lock system comprising an arrangement according to claim 1.

27. The lock system according to claim 26, further comprising an inner handle engaging the inner spindle and an outer handle engaging the outer spindle.

28. A lock system comprising:
an arrangement according to claim 25;
an inner handle engaging the inner spindle; and
an outer handle engaging the outer spindle;
wherein the torsion spring is arranged to clamp one of the inner handle or the outer handle.

29. The lock system according to claim 26, further comprising a latch including the follower.

30. The lock system according to claim 29, wherein the latch is a tubular latch.
